(19) United States
(12) Patent Application Publication
(10) Pub. No.: US 2026/0189174 A1
(43) Pub. Date: Jul. 2, 2026

(54) SEMITRANSPARENT THERMOPHOTOVOLTAIC ARCHITECTURE

(71) Applicant: The Regents of The University of Michigan, Ann Arbor, MI (US)

(72) Inventors: Rebecca LENTZ, Ann Arbor, MI (US); Bosun Roy LAYINDE, Ann Arbor, MI (US); Tobias BURGER, Ann Arbor, MI (US); Zachary BERQUIST, Ann Arbor, MI (US); Stephen R. FORREST, Ann Arbor, MI (US); Andrej LENERT, Ann Arbor, MI (US)

(73) Assignee: The Regents of The University of Michigan, Ann Arbor, MI (US)

(21) Appl. No.: 19/129,442

(22) PCT Filed: Nov. 14, 2023
(86) PCT No.: PCT/US2023/037243

§ 371 Date: May 13, 2025

Related U.S. Application Data
(60) Provisional application No. 63/425,466, filed on Nov. 15, 2022.

(51) Int. Cl. H02S 10/30

(52) U.S. Cl. CPC H02S 10/30

(57) ABSTRACT

Recent advances in thermophotovoltaic (TPV) power generation have produced notable gains in efficiency, particularly at very high emitter temperatures. However, there remains substantial room for improving TPV conversion of waste, solar, and nuclear (WSN) heat streams at temperatures below 1100° C. The concept of transmissive spectral control enables efficient recuperation of below bandgap photons by allowing them to transmit through the cell to be absorbed by a secondary emitter. A semitransparent TPV cell is fabricated of a thin InGaAs/InP heterojunction membrane supported by an infrared-transparent heat-conducting substrate. The device absorbs less than 1% of below bandgap radiation, resulting in a TPV efficiency of 32.5% at an emitter temperature of 1036° C. This represents an 8% absolute improvement in efficiency relative to the best TPV devices at such low temperatures. By enabling near-zero photon loss, the semitransparent architecture facilitates high TPV efficiencies over a wide range of applications.

### CROSS-REFERENCE TO RELATED APPLICATIONS

This application claims the benefit of U.S. Provisional Application No. 63/425,466, filed Nov. 15, 2022. The entire disclosure of the above application is incorporated herein by reference.

### FIELD

The present disclosure relates to a semitransparent thermophotovoltaic architecture.

### BACKGROUND

The performance of thermophotovoltaic (TPV) cells has increased substantially over the last several years, with reports of TPV efficiency surpassing 30% using single-junction cells, and 40% using tandems. These gains have been demonstrated using group III-V semiconductors (e.g., In_{0.53}Ga_{0.47}As lattice matched to InP) with wider bandgaps compared to conventional Sb-based TPV cells. Although these materials exhibit advantageous optical and charge carrier collection properties, they typically require emitter temperatures (Tₕ) above 1200° C. Applications in stationary energy storage using thermal batteries may support extreme emitter temperatures as high as 2400° C., however, a wide range of thermal sources are at temperatures below 1100° C., including waste, concentrating solar thermal, and nuclear heat. In particular, the cement, chemical, iron and steel industries represent a large fraction of global industrial energy use and emissions with substantial waste heat streams at temperatures ranging from 700 to 1100° C.

Translating recent improvements in cell performance to waste, solar and nuclear (WSN) applications is challenging since lower temperatures introduce substantial spectral (photon) and charge carrier losses. This can be appreciated by noting that TPV efficiency (η_{TPV}) is a product of spectral management (SE⋅IQE) and charge management (VF⋅FF) efficiencies. Here, SE, IQE, VF and FF are the spectral and internal quantum cell efficiencies, and the voltage and fill factors, respectively. Lower temperature emitters radiate a larger fraction of power at energies below the cell bandgap (i.e., the out-of-band, OOB, radiation), resulting in lower SE. The conventional solution to this problem is to decrease the cell bandgap using Sb-based III-Vs; however, the voltage penalties associated with non-radiative recombination are prohibitively large in these materials, which results in poor charge management. Alternatively, light management techniques that suppress OOB absorptance (A_{OOB}) can allow for the use of highly efficient III-Vs such as In_{0.53}Ga_{0.47}As (bandgap of 0.74 eV) in WSN applications by maintaining high spectral efficiency at lower emitter temperatures.

Existing techniques for suppressing OOB radiation in TPVs can be broadly categorized as emissive and reflective. FIG. 1 shows the spectral efficiency corresponding to the best measured In_{0.53}Ga_{0.47}As (InGaAs) TPV efficiencies as a function of WSN-relevant emitter temperatures. The lowest SE region corresponds to selective emitters that are designed to preferentially emit above-bandgap (i.e., in-band, IB) radiation while suppressing OOB emission. Although these emitters have demonstrated OOB emittance as low as 7% at room temperature, the emissive properties are generally much higher (>14%) when characterized at the appropriate operating temperature. In contrast, cells with conventional metal back surface reflectors (m-BSRs) exhibit A_{OOB} as low as 5%. These cells absorb IB radiation while reflecting OOB radiation back to the emitter, which re-heats the emitter and facilitates recuperation of otherwise unusable power. Beyond m-BSRs, cells that feature a low-index layer separating the absorber from the rear metal, including patterned dielectric back contact and air-bridge cells, have enabled A_{OOB} as low as 2% (integrated from 0° to 90° incidence angle). Despite these recent advances in spectral management, a technique that provides nearly complete OOB suppression (A_{OOB}<1.5%) has yet to be demonstrated. Accessing this regime would enable TPV cells based on InGaAs to maintain high efficiencies at temperatures relevant to WSN thermal streams.

This section provides background information related to the present disclosure which is not necessarily prior art.

### SUMMARY

This section provides a general summary of the disclosure, and is not a comprehensive disclosure of its full scope or all of its features.

A thermophotovoltaic system is presented. The system is comprised of a planar substrate that is transparent to infrared radiation; and at least one photovoltaic cell disposed on the substrate, where the photovoltaic cell is comprised of multiple device layers forming a p-n junction. Two thermal emitters are positioned on opposing sides of the substrate. Each thermal emitter is configured to emit electromagnetic radiation such that a portion of the electromagnetic radiation passes through the substrate.

In one implementation, the thermophotovoltaic system includes an array of thermal emitters. For each pair of adjacent thermal emitters in the array of thermal emitters, a divider is positioned between opposing surfaces of the adjacent thermal emitters, where the divider is transparent to infrared radiation. For each divider, a photovoltaic cell is disposed on each surface of the divider that is facing a thermal emitter in the array of thermal emitters, where each photovoltaic cell is comprised of multiple device layers forming a p-n junction.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a graph showing current performance in spectral control at moderate-to-low emitter temperatures.

FIGS. 2A and 2B are diagrams illustrating the concept of transmissive spectral control in a thermophotovoltaic system.

FIG. 3 is a schematic of an example embodiment of a photovoltaic cell.

FIG. 4A is a graph showing transmittance of the semitransparent cell.

FIG. 4B is a chart showing the contributions of active and inactive layers to out-of-band absorption for a reflective cell and the semitransparent cell.

FIG. 4C is a graph showing the J-V characteristics of the semitransparent cell.

FIG. 5A is a graph showing the TPV efficiency of the semitransparent cell as a function of variable emitter temperature.

FIG. 5B is a graph showing spectral management as a function of carrier management for TPV cells in a temperature range of 1000 degrees C. to 1050 degrees C.

FIG. 6 is a graph showing dependency of TPV efficiency substrate thickness.

FIG. 7 is diagram of an alternative embodiment of the thermophotovoltaic system.

FIG. 8 is diagram of another alternative embodiment of the thermophotovoltaic system.

FIG. 9 is a diagram of an example thermophotovoltaic system having an array of thermal emitters.

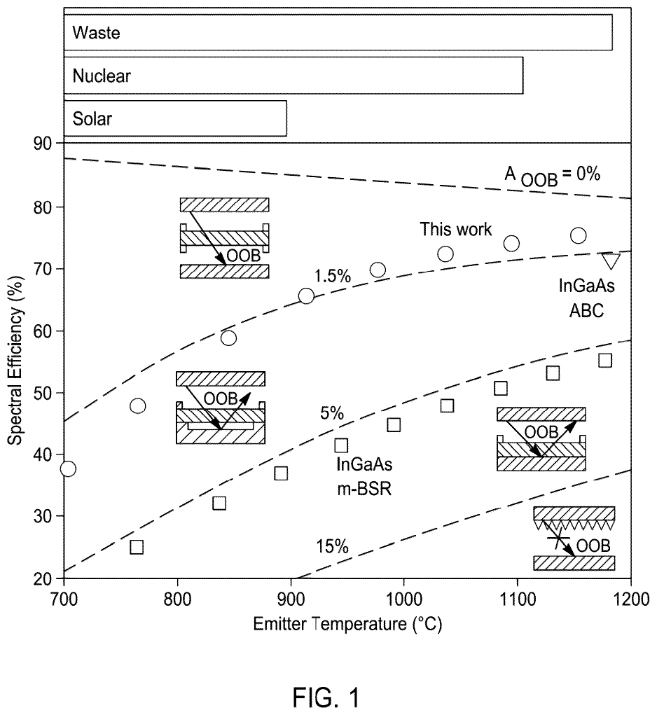

Corresponding reference numerals indicate corresponding parts throughout the several views of the drawings.

### DETAILED DESCRIPTION

Example embodiments will now be described more fully with reference to the accompanying drawings.

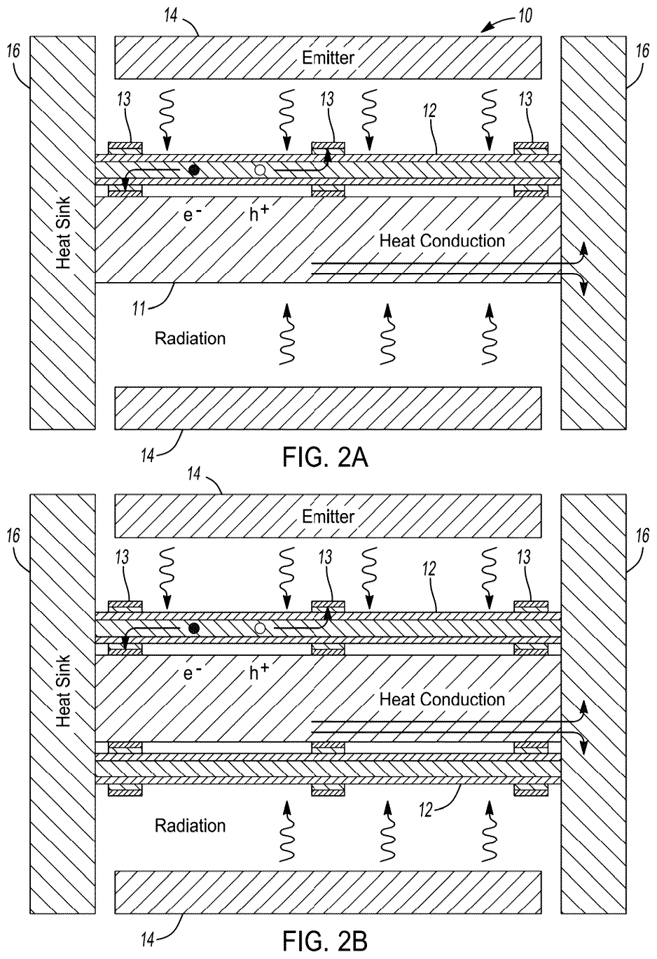

FIGS. 2A and 2B illustrate the concept of transmissive spectral control in a thermophotovoltaic system 10. The thermophotovoltaic system 10 is comprised of at least one photovoltaic cell 12 that is positioned between two thermal emitters 14 as seen in FIG. 2A. Alternatively, two photovoltaic cells 12 are disposed on a planar substrate 11 with one photovoltaic cell on each side of the substrate 11 as seen in FIG. 2B. Each of the thermal emitters 14 is configured to emit electromagnetic radiation. Of note, the substrate 11 is comprised of a material that is transparent to infrared radiation. Example materials include but are not limited to silicon, diamond and sapphire.

A plurality of electrodes 13 are electrically coupled to the photovoltaic cells. Each electrode pair in the plurality of electrode is disposed on opposing sides of a given photovoltaic cell and spatially aligned with each other. The electrodes are used to extract electrical current out of the photovoltaic cells. The electrodes may be made of materials including but not limited to gold, titanium and platinum.

Surrounding the photovoltaic cells with the emission sources is possible because the heat source is local. In this configuration, absorption of in band radiation excites electron-hole pairs in the photovoltaic cells 12, which are separated and extracted at the contacts; out-of-band (OOB) radiation transmits through the cell and is absorbed by the thermal emitter on the opposite side. Waste heat may be conducted laterally along the length of the transparent substrate 11 to a conductive heat sink 16. Due to this symmetry, the net movement of photons is zero along the centerline of the cells. This implies that the centerlines act as perfect broadband reflectors, unlike dielectric and metal mirrors which are limited by bandwidth or intrinsic absorption (associated with finite electrical conductivity), respectively.

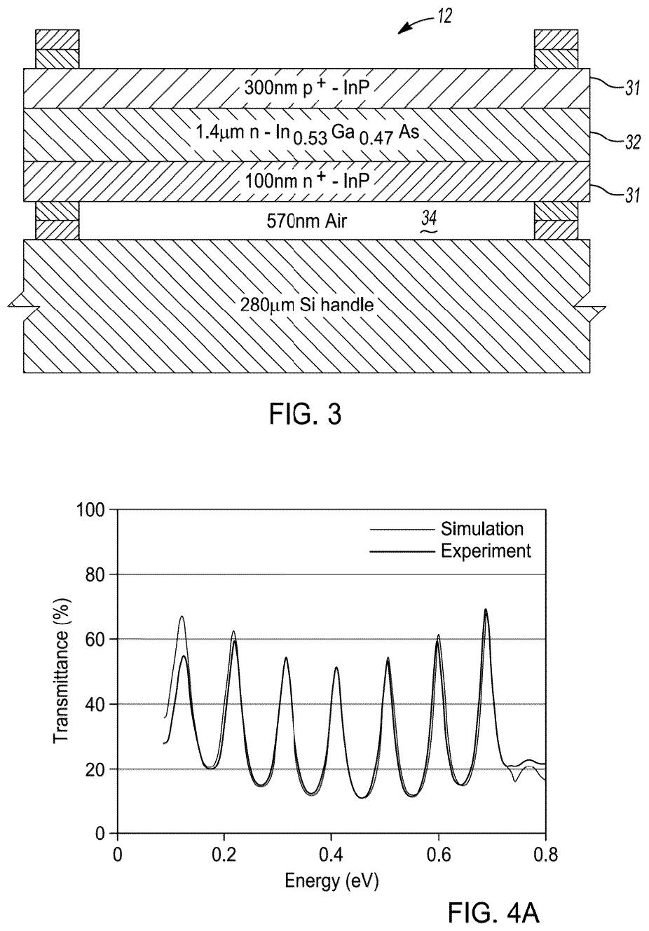

FIG. 3 depicts an example embodiment of a photovoltaic cell 12 which may be used in the system. Photovoltaic cell 12 is comprised of multiple device layers forming a p-n junction. In the example embodiment, the multiple device layers include a layer of indium gallium arsenide 32 sandwiched between layer of indium phosphide 31. Other semiconductor materials are contemplated by this disclosure, including semiconductors selected from group III-V elements.

The photovoltaic cell 12 preferably includes a spacer layer 34 positioned between the multiple device layers of the at least one photovoltaic cell and the substrate 11. The spacer layer 34 includes one or more cavities (or holes) extending between the multiple device layers of the at least one photovoltaic cell and the substrate. In an example embodiment, the one or more cavities are filled with air. In other embodiments, the one or more cavities may be filled with magnesium fluoride or other types of semiconductor materials.

Thus, the photovoltaic cell 12 builds upon recent demonstration of air-bridge thermophotovoltaic cells that achieved power conversion efficiencies of 32% at an emitter temperature of ˜1200° C. The air-bridge cell, however, exhibited A_{OOB}≈2% when integrated over all incidence angles, mainly due to relatively high absorption in a gold mirror at oblique angles. To overcome this limitation, the photovoltaic cell 12 described above eliminates the gold mirror and retains a transparent substrate (“fin”) that allows transmission of incident OOB thermal radiation. Owing to minimal OOB loss (˜1%), the photovoltaic cell 12 demonstrated here achieves 72.2±0.2% spectral efficiency and 32.5±0.1% TPV efficiency at an emitter temperature of 1036° C. The latter result represents an 8% absolute improvement (˜33% relative) over previously measured cells at comparable temperatures.

Fabrication of the example embodiment of the photovoltaic cell 12 shown in FIG. 3 was as follows. The heterostructure was epitaxially grown on a 300 μm thick (100) InP substrate using metalorganic chemical vapor deposition (University Wafer Inc., South Boston, MA, USA). The epitaxial film consists of a 200 nm thick Mg-doped (1×10¹⁸ cm⁻³) In_{0.53}Ga_{0.47}As (InGaAs) front contact layer, 300 nm Mg-doped (1×10¹⁸ cm-3) InP front window layer, 1.4 μm thick Si-doped (1×10¹⁷ cm⁻³) InGaAs absorber layer, 100 nm Si-doped (1×10¹⁸ cm⁻³) InP rear window layer, and 100 nm thick Si-doped (1×10¹⁸ cm⁻³) InGaAs rear contact layer. All layers are photolithographically patterned using SPR 220 3.0 photoresist (Kayaku Advanced Material Inc., Westborough, MA, USA.). Metal layers are patterned using LOR 10B (Kayaku Advanced Material Inc., Westborough, MA, USA.) and SPR 220 3.0 bilayer photoresist. The epitaxial sample and a Si wafer are soaked in buffered HF for 90s to remove the native surface oxides. The cathode contact grid (10 nm Ti/225 nm Au) is deposited by electron-beam evaporation in a chamber with a base pressure of 4×10−6 torr. Grid lines are 10 μm wide on a 64 μm pitch. The epitaxial sample is soaked in 1:1:8 H₃PO₄:H₂O₂:H₂O for 20s to remove the 100 nm thick InGaAs rear contact layer in the area between grid lines, while the contact layer beneath the grid lines is protected. Parallel gold patterns on the epitaxial sample and Si wafer (the substrate) are spatially aligned and cold-weld bonded using a flip chip bonder (Finetech) by applying heat (150° C.) and pressure (2 MPa) for 5 min. The bond strength is increased at the same temperature and higher pressure (8 MPa) for 10 min using an EVG 510 wafer bonder. The bonded sample is soaked in HCl for 90 min to remove the InP substrate. This process is compatible with non-destructive epitaxial lift-off techniques, which may preserve the expensive InP growth substrate for additional growths. The device mesa is etched by alternating soaks in InGaAs (1:1:8 H₃PO₄:H₂O₂:H₂O) and InP (1:1 HCl:H₂O) etchant solutions. The anode contact grid (10 nm Ti/30 nm Pt/560 nm Au) is deposited by electron-beam evaporation. The anode contact grid is spatially aligned to the buried cathode contact grid epitaxial layer to shade the absorptive InGaAs contact layers. Lastly, the sample is soaked in 1:1:8 H₃PO₄:H₂O₂:H₂O 60s to remove the 300 nm thick InGaAs front contact between the grid lines. This particular fabrication method is merely illustrative and not intended to be limiting. Other fabrication technique are contemplated by this disclosure.

To reach high TPV efficiency at low emitter temperatures, the thermophotovoltaic system 10 must combine efficient electrical and thermal management with near-zero photon losses. To this end, the design of the photovoltaic cell, gridlines, and substrate should minimize absorption of OOB photons without degrading other performance characteristics. In the example embodiment, a silicon substrate allows for lateral heat conduction to a heat sink at the cell edges. Gold patterns are aligned and cold-weld bonded using a flip chip and wafer bonding tool. The process retains a 570 nm air-gap while allowing light to transmit through the substrate between the grid lines. To minimize parasitic absorption, the n-type In_{0.53}Ga_{0.47}As absorber and InP layer are 1.7 μm thick with a dopant concentration of 1×10¹⁷ cm⁻³; whereas, the heavily p-doped InGaAs (1×10¹⁸ cm⁻³) contact layers are shaded by the metal gridlines. The substrate is a double-side polished silicon that is chemically compatible with the III-V processing protocol and has a high thermal conductivity of 130 W/m/K at 25° C. Use of intrinsic, float zone silicon minimizes free carrier and impurity absorption leading to a low mid-IR extinction coefficient (<2×10⁻⁴).

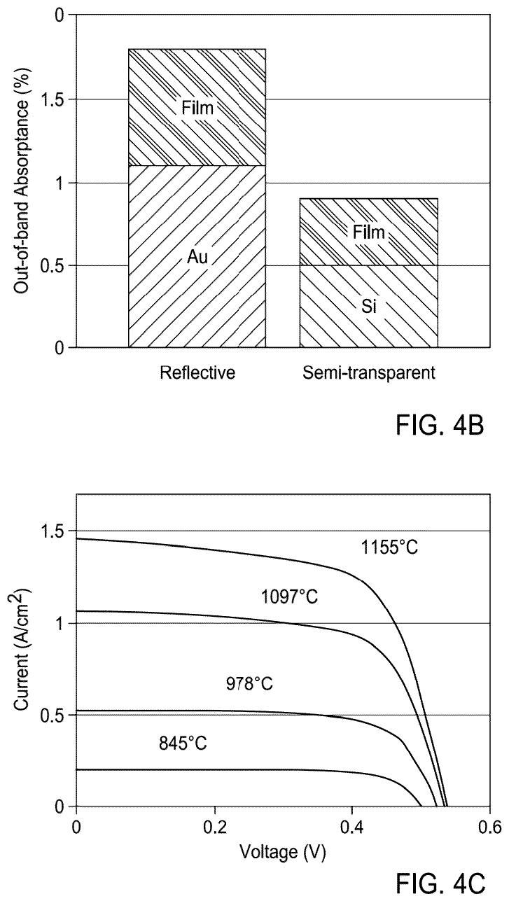

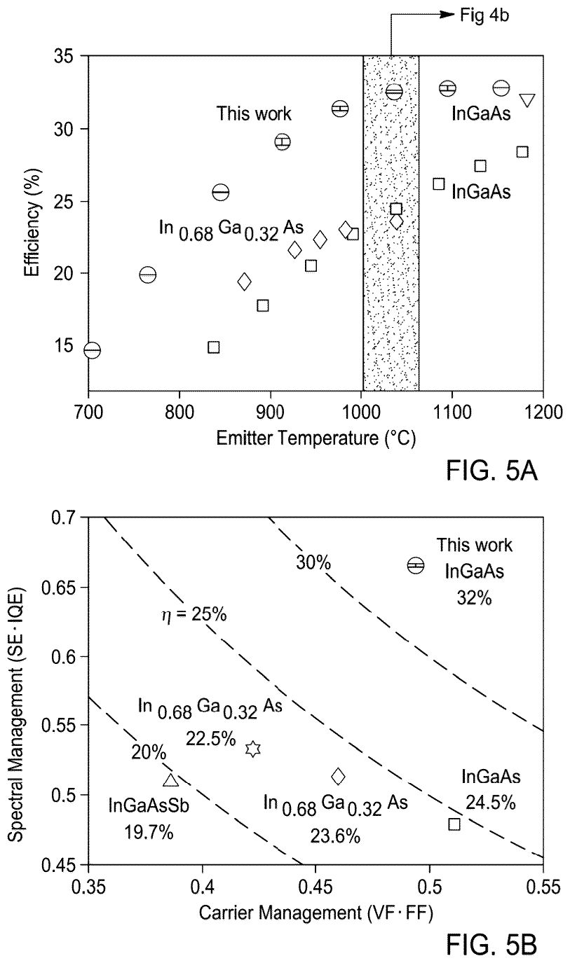

FIG. 4A depicts the spectral transmittance of the cell at normal incidence as measured by Fourier transmission IR spectrometry. Experimental transmittance is observed to marginally deviate from simulation for energies less than 0.13 eV. This measurement is paired with the spectral reflectance of the semitransparent cell to yield A_{OOB}=0.9%, as weighted by emission from a blackbody at 1227° C. (1500 K). For reference, a reflective air-bridge control fabricated using the same epitaxial growth exhibits a measured A_{OOB}=1.8%.

Transfer matrix optical modeling is used to estimate the contributions of the Au reflector and the Si substrate in the reflective and semitransparent cells. FIG. 4B shows the contributions of the active and inactive layers of each cell to the total OOB absorptance. The Au absorbs 1.1% and the heterostructure absorbs 0.7% in the reflective air-bridge cell. In contrast, the polished Si substrate only absorbs 0.5%. The remaining parasitic absorption (0.4%) is assigned the InGaAs/InP heterostructure. Thus, results show that by removing the Au reflector, absorption is substantially reduced, thus demonstrating the fabrication of semitransparent TPV devices with A_{OOB}<1.5%.

To characterize the power output and efficiency of the cells, voltage sweeps were performed under illumination by a SiC globar with an ellipsoidal concentrator. FIG. 4C depicts a set of illuminated current density-voltage (J-V) characteristics for the semitransparent cell, with Tₕ ranging from 700° C. to 1215° C. Short-circuit current densities, J_{sc}, are in the range of a realistic TPV system (view factor of 0.75). The voltage factors are higher than previous works, which is attributed to improved wafer quality. The series resistance and saturation dark currents, extracted from fitting both illuminated and dark measurements, show that patterning the rear gold layer slightly increases series resistance. Although not shown, thicker gold gridlines can be used to mitigate this effect.

FIG. 5A shows the TPV efficiency (nTPv) vs. Tₕ for the semitransparent cell compared to the best previously reported measured efficiencies within this Tₕ range. η_{TPV} is defined as the ratio of power generated to the radiative heat absorbed by the cell. The efficiency decreases with decreasing emitter temperature due to the red-shifted emission spectrum, which increases spectral losses at photon energies <0.13 eV. PCE also decreases with increasing emitter temperature due to cell heating. Note that the semitransparent geometry requires lateral heat conduction along the substrate to moderate cell temperature; whereas a reflective cell can be directly cooled from the back. Despite these losses, the semitransparent cell achieves PCE=32.5±0.1% at ˜1036° C. This represents an 8% absolute (˜33% relative) improvement compared to the prior highest efficiency of 24.5% within this WSN-relevant emitter temperature range of 1000° C. to 1050° C. Also note that the semitransparent cell exhibits a ˜6% relative improvement compared to the reflective air-bridge control at ˜1036° C.

To further highlight the improvements relative to state-of-the-art approaches, contributions to the TPV efficiency due to the spectral management and carrier management efficiencies are shown in FIG. 5B. The improved spectral management of the semitransparent design is captured by the relative position of the purple data point along the vertical axis. In addition, the semitransparent device exhibits a high carrier management efficiency, comparable to the best InGaAs devices using conventional BSRs. Overall, this result demonstrates that the semitransparent architecture does not compromise carrier management at WSN temperatures, while providing a substantial gain in spectral management.

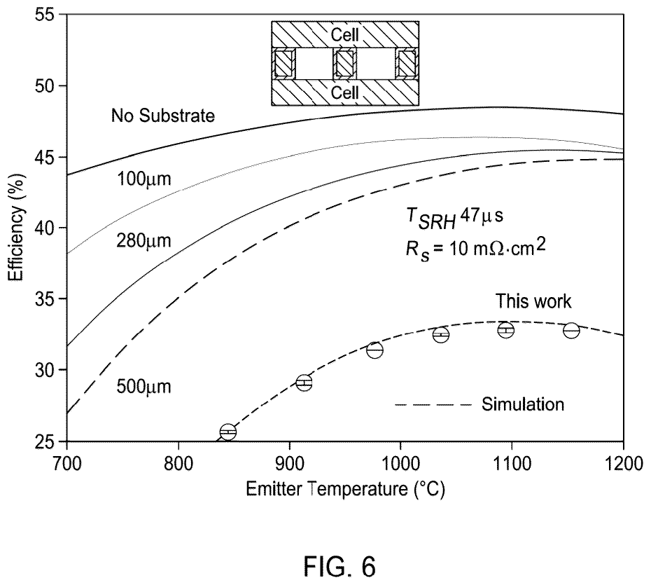

For demonstration purposes, optical and electronic simulations were used to optimize the design of a bifacial semitransparent cell based on the demonstrated device characteristics. The effects of material quality and gridline optimization is modeled by assuming a Shockley-Read-Hall recombination lifetime of T_{SRH}=47 μs, which to our knowledge is the longest reported for InGaAs, and a series resistance Rₛ=10 mΩ cm² that has been attained for similar patterned dielectric back contact devices. The cell is assumed to be 1 cm in length and supported at both ends by a 25° C. heat sink. FIG. 6 shows the dependence of TPV efficiency on these carrier management assumptions. Notably, the efficiency of a bifacial semitransparent cell with a 280 μm thick Si substrate is expected to exceed 40% with a 1000° C. emitter. FIG. 6 further shows the dependence on substrate thickness, which affects both cell temperature and optical performance. The model predicts that thinner substrates (e.g., 100 μm) improve performance at lower emitter temperatures, at which heat conduction is not performance limiting. In contrast, a 500 μm thick substrate may provide better heat conduction, but it leads to increased parasitic absorptance at long wavelengths, resulting in lower efficiencies within this temperature range.

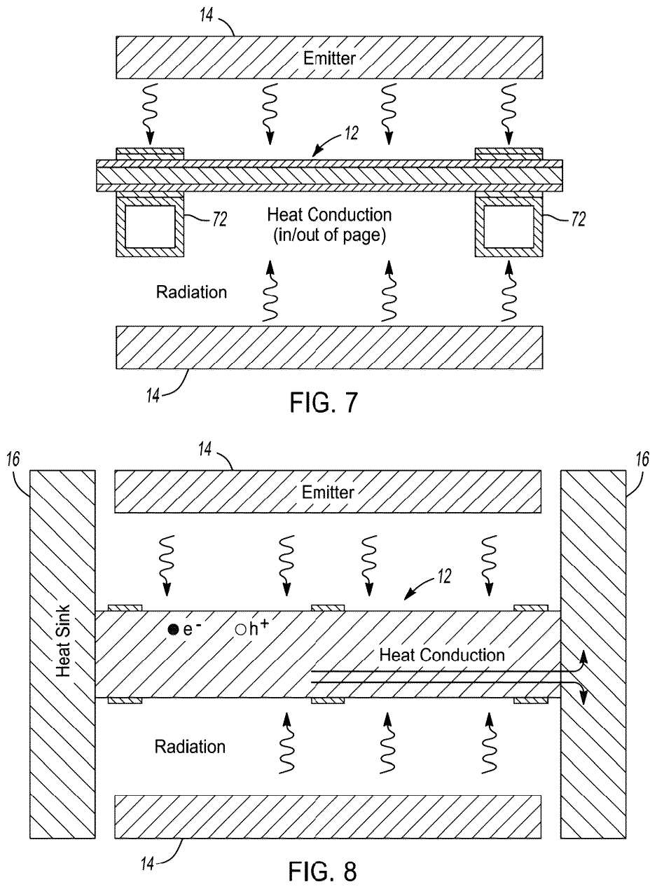

In one alternative embodiment, the planar substrate may be replaced with heat conducting grid lines, for example as seen FIG. 7. At least photovoltaic cell 12 as described above is supported by the gridlines 72. In some instances, a photovoltaic cell 12 is attached to each side of the gridlines 72. In this embodiment, the gridlines conduct the electrical power from the photovoltaic cells as well as the heat load. The gridlines 72 may comprise highly conductive materials, such as copper, graphite, or other emerging materials, such as cubic boron arsenide. The gridlines 72 may be coated with gold to reduce optical loss. This configuration has the potential to reduce OOB absorptance to A_{OOB}<0.5% and enable a peak efficiency of 48.5% at 1000° C., provided that the active semiconductor membrane is the only source of parasitic absorption.

In another alternative embodiment, a photovoltaic cell 12 as described above is disposed between two thermal emitters 14 without the use of a substrate as seen in FIG. 8. In this case, the photovoltaic cell is thick enough to conduct heat laterally by itself to the heat sink 16 without the use of a substrate. The photovoltaic cell can be made of materials that are transparent to infrared radiation such as but not limited to silicon. Electrodes are patterned on the photovoltaic cell to extract current.

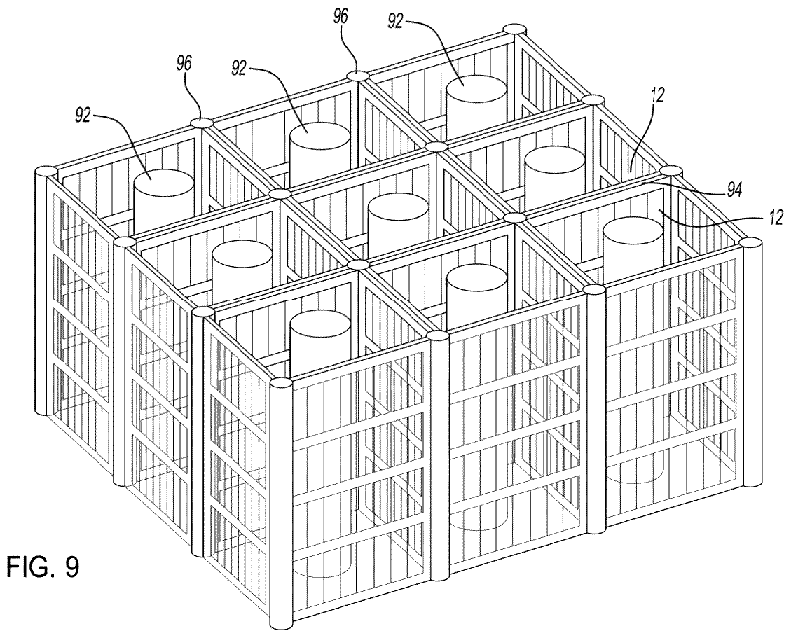

In another implementation, photovoltaic cells can be interdigitated with multiple thermal emitters in a cross-flow geometry as seen in FIG. 9. More specifically, the thermal emitters 92 are arranged in an array, such that each thermal emitter 92 can emit electromagnetic radiation in multiple directions. In this example, the thermal emitters 92 are cylinders although other shapes are contemplated by this disclosure. For each pair of adjacent thermal emitters in the array of thermal emitters, a divider 94 is positioned between opposing surfaces of the adjacent thermal emitters 92, where the divider 94 is transparent to infrared radiation. A photovoltaic cell 12 is then disposed on each surface of the divider 94 that is facing a thermal emitter in the array of thermal emitters. A heat pipe 96 is preferably disposed at each intersection in the array. The heat pipe 96 may be comprised of copper or other conductive materials. This arrangement decreases the heat diffusion path length by a factor of two as compared to an open-ended fin by thermally grounding the fins along two of its edges. When the path length is halved, the temperature rise decreases by a factor of four.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A thermophotovoltaic system, comprising:
a planar substrate that is transparent to infrared radiation;
at least one photovoltaic cell disposed on the substrate, where the photovoltaic cell is comprised of multiple device layers forming a p-n junction;
two thermal emitters positioned on opposing sides of the substrate, each thermal emitter is configured to emit electromagnetic radiation such that a portion of the electromagnetic radiation passes through the substrate.

2. The thermophotovoltaic system of claim 1 wherein the substrate is comprised of silicon.

3. The thermophotovoltaic system of claim 1 wherein the substrate is comprised of either diamond or sapphire.

4. The thermophotovoltaic system of claim 1 further comprises a second photovoltaic cell disposed on opposing side of the substrate, where the second photovoltaic cell is comprised of multiple device layers forming a p-n junction.

5. The thermophotovoltaic system of claim 1 wherein the multiple device layers include a layer of indium gallium arsenide sandwiched between layer of indium phosphide.

6. The thermophotovoltaic system of claim 5 further comprises a spacer layer positioned between the at least one photovoltaic cell and the substrate, and the spacer layer includes at least one cavity formed between the at least one photovoltaic cell and the substrate.

7. The thermophotovoltaic system of claim 1 further comprises a plurality of electrodes electrically coupled to the at least one photovoltaic cell, each electrode pair in the plurality of electrode is disposed on opposing sides of the at least one photovoltaic cell and spatially aligned with each other.

8. The thermophotovoltaic system of claim 1 further comprises a heat sink thermally coupled to the substrate.

9. A thermophotovoltaic system, comprising:
a photovoltaic cell having shape of a rectangular cuboid and comprised of multiple device layers forming a p-n junction, where the photovoltaic cell is configured to be transparent to infrared radiation;
a heat sink thermally coupled to longitudinal ends of the photovoltaic cell; and
two thermal emitters positioned on opposing sides of the photovoltaic cell, each thermal emitter is configured to emit electromagnetic radiation such that a portion of the electromagnetic radiation passes through the photovoltaic cell.

10. The thermophotovoltaic system of claim 9 wherein the substrate is comprised of silicon.

11. The thermophotovoltaic system of claim 9 wherein the multiple device layers include a layer of indium gallium arsenide sandwiched between layer of indium phosphide.

12. The thermophotovoltaic system of claim 9 further comprises a plurality of electrodes electrically coupled to the at least one photovoltaic cell, each electrode pair in the plurality of electrode is disposed on opposing sides of the at least one photovoltaic cell and spatially aligned with each other.

13. A thermophotovoltaic system, comprising:
an array of thermal emitters, each thermal emitter is configured to emit electromagnetic radiation in multiple directions;
for each pair of adjacent thermal emitters in the array of thermal emitters, a divider is positioned between opposing surfaces of the adjacent thermal emitters, where the divider is transparent to infrared radiation; and
for each divider, a photovoltaic cell is disposed on each surface of the divider that is facing a thermal emitter in the array of thermal emitters, where each photovoltaic cell is comprised of multiple device layers forming a p-n junction.

14. The thermophotovoltaic system of claim 13, wherein each thermal emitter is in shape of a cylinder.

15. The thermophotovoltaic system of claim 13 further comprises a heat pipe disposed at each intersection of the array of thermal emitters.

16. The thermophotovoltaic system of claim 13 wherein the multiple device layers include a layer of indium gallium arsenide sandwiched between layer of indium phosphide.

17. The thermophotovoltaic system of claim 13 further comprises a spacer layer positioned between each photovoltaic cell and the surface of the divider, and the spacer layer includes at least one cavity formed between a given photovoltaic cell and the surface of the divider.

18. The thermophotovoltaic system of claim 13 further comprises a plurality of electrodes electrically coupled to each photovoltaic cell, each electrode pair in the plurality of electrode is disposed on opposing sides of a given photovoltaic cell and spatially aligned with each other.
